(19) United States
(12) Patent Application Publication
(10) Pub. No.: US 2022/0311107 A1
(43) Pub. Date: Sep. 29, 2022

(54) BATTERY PACK

(71) Applicant: MAKITA CORPORATION, Anjo-shi (JP)

(72) Inventor: Hideyuki TAGA, Anjo-shi (JP)

(73) Assignee: MAKITA CORPORATION, Anjo-shi (JP)

(21) Appl. No.: 17/682,330

(22) Filed: Feb. 28, 2022

(30) Foreign Application Priority Data
Mar. 23, 2021 (JP) 2021-048528

(51) Int. Cl. H01M 50/562; H01M 50/55

(52) U.S. Cl. CPC H01M 50/562; H01M 50/55; H01M 2220/30

(57) ABSTRACT

A battery pack may be configured to be attached to and detached from an electric device including device-side terminals. The battery pack may include a battery cell, a circuit board electrically connected to the battery cell, and battery-side terminals electrically connected to the circuit board, and configured to be electrically connected to the device-side terminals by contacting the device-side terminals. The battery-side terminals may include a positive power terminal and a negative power terminal, and at least one signal terminal. The positive power terminal may be plated with a first metal on its surface. One of the at least one signal terminal may be plated with a second metal on its surface. The first metal may be a pure metal except for Ag or an alloy not containing Ag. The second metal may be a pure metal that is a noble metal or a noble metal alloy.

### CROSS-REFERENCE TO RELATED APPLICATION

This application claims priority to Japanese patent application No. 2021-048528, filed on Mar. 23, 2021, the entire contents of which are incorporated herein by reference.

### TECHNICAL FIELD

The art disclosed herein relates to a battery pack.

### BACKGROUND

Japanese Patent Application Publication No. 2017-518193 describes a battery pack configured to be detachably attached to an electric device or a charger having device-side terminals. The battery pack includes a battery cell, a circuit board electrically connected to the battery cell, and battery-side terminals electrically connected to the circuit board and configured to be electrically connect with the device-side terminals by contacting the device-side terminals. The battery-side terminals include a positive power terminal and a negative power terminal for discharging from the battery cell and charging the battery cell, and at least one signal terminal electrically connected to the circuit board for signal communication with the circuit board.

### SUMMARY

In the battery pack as described above, short-circuiting and conduction defects need to be suppressed in the battery-side terminal. The disclosure herein provides art capable of suppressing short-circuiting and conduction defects in a battery-side terminal of a battery pack.

A battery pack disclosed in the herein may be configured to be attached to and detached from an electric device or a charger including device-side terminals. The battery pack may comprise: a battery cell; a circuit board electrically connected to the battery cell; and battery-side terminals electrically connected to the circuit board and configured to electrically connect to the device-side terminals by contacting the device-side terminals. The battery-side terminals may comprise: a positive power terminal and a negative power terminal for discharging from the battery cell and charging the battery cell; and at least one signal terminal electrically connected to the circuit board for signal communication with the circuit board. The positive power terminal may be plated with a first metal on its surface. One of the at least one signal terminal may be plated with a second metal on its surface. The first metal may be a pure metal other than Ag or an alloy not containing Ag. The second metal may be a pure metal that is a noble metal or a noble metal alloy.

When the battery pack is used in a high-moisture environment, metal on the surface of the positive power terminal may be ionized, move on the control circuit board toward the negative power terminal, and deposit as metal on the surface of the negative power terminal. Such a phenomenon is called ion migration. When the metal deposited on the negative power terminal grows on the control circuit board, short-circuiting may occur in the control circuit board. The ion migration tends to occur the most with Ag, and with PC and Cu the second most. Further, the ion migration tends to occur when a large voltage is applied, while it tends not to occur when a small voltage is applied. As such, the ion migration tends to occur in the positive and negative power terminals and tends not to occur in the signal terminal(s). Due to this, as aforementioned, by plating the surface of the positive power terminal with a pure metal other than Ag or with an alloy not containing Ag, Ag ionization on the surface of the positive power terminal can be suppressed, and the short-circuiting caused by the ion migration can be suppressed. The pure metal other than Ag or the alloy not containing Ag as aforementioned may be a pure metal other than Ag, Pb or an alloy not containing Ag, Pb, or may be a pure metal other than Ag, Pb, Cu or an alloy not containing Ag, Pb, Cu.

In the state in which the battery pack is attached to the electric device or the charger, the battery-side terminals are maintained in contact with the device-side terminals of the electric device or the charger. In this state, when micro-vibration is repeatedly applied to the battery-side terminals, partial wear progresses on the surfaces of the battery-side terminals, by which metal debris worn off of the surfaces of the battery-side terminals oxidizes and accumulates on the surfaces of the battery-side terminals. Such a phenomenon is called fretting corrosion. As the oxidized debris accumulates on the surfaces of the battery-side terminals, conduction defects of the battery-side terminals could occur. In general, noble metals tend not to oxidize, thus they are resistant against such conduction defects caused by the fretting corrosion. To the contrary, since base metals are prone to oxidization, they are susceptible to such conduction defects caused by the fretting corrosion. Further, the conduction defects caused by the fretting corrosion tend not to occur when a large voltage is applied whereas the conduction defects tend to occur when a small voltage is applied, thus the conduction defects tend to occur in the positive and negative power terminals and tend not to occur in the signal terminal(s). Due to this, by plating the surface of the at least one signal terminal with a pure metal that is a noble metal or a noble metal alloy as aforementioned, the conduction defects caused by the fretting corrosion can be suppressed.

### BRIEF DESCRIPTION OF DRAWINGS

FIG. 1 is a perspective view of a battery pack 2 of an embodiment viewed from the front lower right side.

FIG. 2 is a perspective view of the battery pack 2 of the embodiment viewed from the rear upper left side.

FIG. 3 is a perspective view of air supply openings 40 and exhaust openings 42 of the battery pack 2 of the embodiment and their vicinities viewed from the front left upper side.

FIG. 4 is a perspective view of a battery cell unit 14 of the battery pack 2 of the embodiment viewed from the front lower right side.

FIG. 5 is a perspective view of battery cells 48 and a cell holder 50 of the battery pack 2 of the embodiment viewed from the front lower right side.

FIG. 6 is perspective views of the battery cells 48 and the cell holder 50 of the battery pack 2 of the embodiment viewed from the rear upper left side.

FIG. 7 schematically shows an electric system of the battery pack 2 of the embodiment.

FIG. 8 is a transverse cross-sectional view of the battery pack 2 of the embodiment.

FIG. 9 is a vertical cross-sectional view of the battery pack 2 of the embodiment.

### DETAILED DESCRIPTION

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved battery packs as well as methods for using and manufacturing the same.

Moreover, combinations of features and steps disclosed in the following detailed description may not be necessary to practice the present disclosure in the broadest sense, and are instead taught merely to particularly describe representative examples of the present disclosure.

Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, a battery pack may be configured to be attached to and detached from an electric device or a charger including device-side terminals. The battery pack may comprise: a battery cell; a circuit board electrically connected to the battery cell; and battery-side terminals electrically connected to the circuit board, and configured to electrically connect to the device-side terminals by contacting the device-side terminals. The battery-side terminals may comprise: a positive power terminal and a negative power terminal for discharging from the battery cell and charging the battery cell; and at least one signal terminal electrically connected to the circuit board for signal communication with the circuit board. The positive power terminal may be plated with a first metal on its surface. One of the at least one signal terminal may be plated with a second metal on its surface. The first metal may be a pure metal other than Ag or an alloy not containing Ag. The second metal may be a pure metal that is a noble metal or a noble metal alloy.

According to the above configuration, short-circuiting caused by ion migration and conduction defects caused by fretting corrosion can be suppressed in the battery-side terminals of the battery pack.

In one or more embodiments, the negative power terminal may be plated with a third metal on its surface. The third metal may be a pure metal other than Ag or an alloy not containing Ag.

According to the above configuration, the short-circuiting caused by the ion migration can be suppressed in the battery-side terminals of the battery pack.

In one or more embodiments, the third metal may be the same metal as the first metal.

According to the above configuration, since plating processes to be performed on the positive and negative power terminals can be integrated, manufacture of the battery pack can be facilitated.

In one or more embodiments, all of the at least one signal terminal may be plated with the second metal on the surface.

According to the above configuration, since plating processes to be performed on all of the at least one signal terminal can be integrated, the manufacture of the battery pack can further be facilitated.

In one or more embodiments, the first metal may be Sn.

According to the above configuration, among the battery-side terminals, sliding performance of terminal(s) plated with the first metal to slide on the device-side terminal(s) can be improved.

In one or more embodiments, the second metal may be Ag.

According to the above configuration, an electric resistance of terminal(s) plated with the second metal among the battery-side terminals can be reduced.

### Embodiment

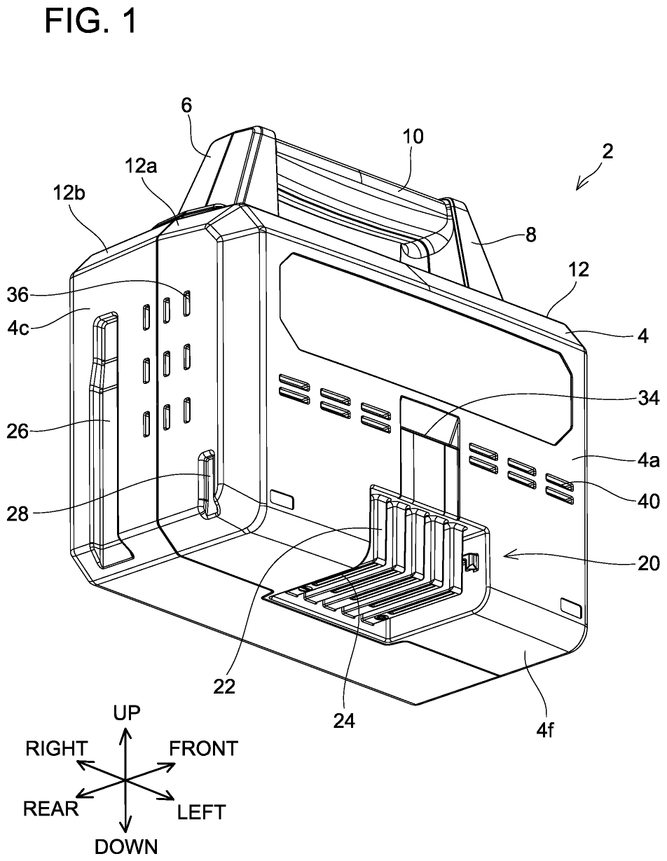

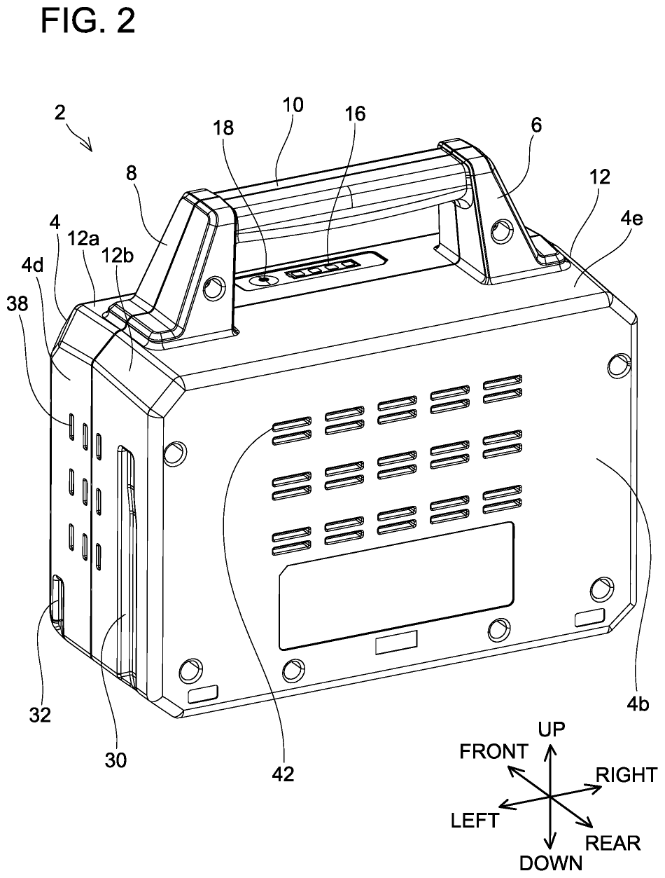

A battery pack 2 shown in FIGS. 1 and 2 is configured to be detachably attached to an electric device (not shown). The electric device can operate by using electric power discharged from the battery pack 2. The electric device may for example be a power tool such as a driver or a drill that uses a motor as its prime mover, or may be an electric working machine such as a grass mower or a blower that uses a motor as its prime mover. Alternatively, the electric device may be an electric device that does not include a motor, such as a lighting device, a radio, and a speaker. Further, the battery pack 2 is configured to be detachably attached to a charger (not shown). The charger is configured to charge the battery pack 2.

The battery pack 2 includes a main body 4, a right support 6, a left support 8, and a handle 10. The main body 4 has a substantially box shape. The main body 4 includes a front surface 4a, a rear surface 4b, a right surface 4c, a left surface 4d, an upper surface 4e, and a lower surface 4f. A dimension of the main body 4 in an up-down direction is larger than a dimension of the main body 4 in a front-rear direction. A dimension of the main body 4 in a left-right direction is larger than the dimension of the main body 4 in the up-down direction. The dimension of the main body 4 in the up-down direction may for example be in a range of 150.0 mm to 250.0 mm, and may more specifically be 171.5 mm. The dimension of the main body 4 in the front-rear direction may for example be in a range of 70.0 mm to 120.0 mm, and may more specifically be 90.0 mm. The dimension of the main body 4 in the left-right direction may for example be in a range of 170.0 mm to 210.0 mm, and may more specifically be 190.0 mm. The dimensions of the main body 4 as above are mere examples, and the dimensions of the main body 4 may each be smaller or larger. The right support 6 protrudes upward from a position near the right end of the upper surface 4e of the main body 4. The left support 8 protrudes upward from a position near the left end of the upper surface 4e of the main body 4. The handle 10 extends in the left-right direction and connects the vicinity of the upper end of the left surface of the right support 6 and the vicinity of the upper end of the right surface of the left support 8. A user can carry the battery pack 2 by holding the handle 10. The battery pack 2 may not include the right support 6, the left support 8, or the handle 10. Weight of the battery pack 2 may for example be in a range of 1.0 kg to 4.0 kg, and may more specifically be 2.2 kg. A rated voltage of the battery pack 2 may for example be in a range of 36 V to 108 V, and may more specifically be 57.6 V. A rated capacity of the battery pack 2 may for example be in a range of 3.0 Ah to 12.0 Ah, and may more specifically be 4.0 Ah. The weight, rated voltage, and rated capacity of the battery pack 2 as described above are mere examples, and the weight, rated voltage, and rated capacity of the battery pack 2 may each be smaller or larger.

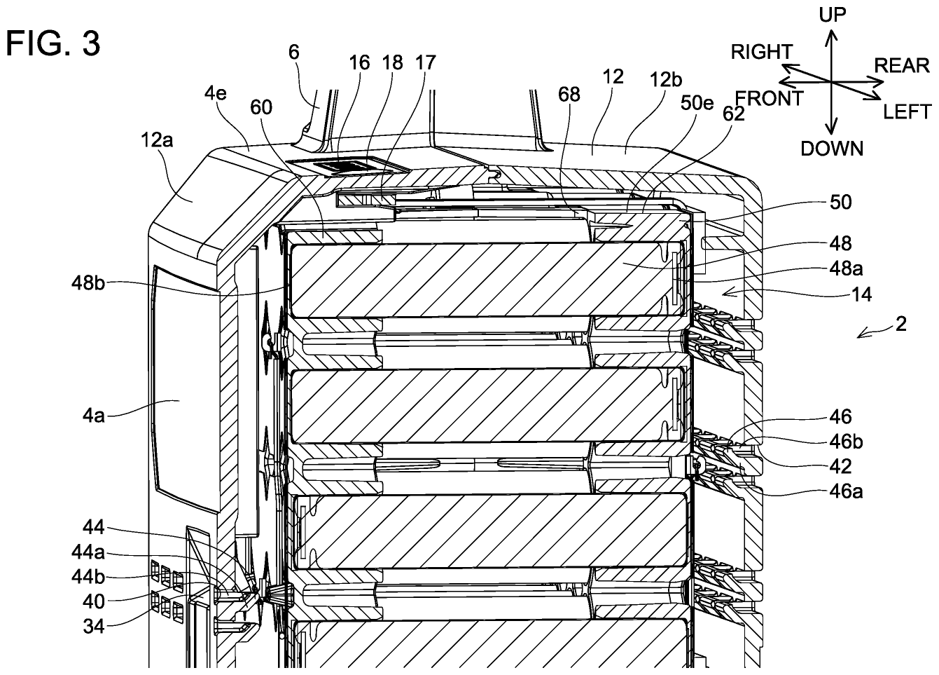

The battery pack 2 includes a casing 12 and a battery cell unit 14 (see FIG. 3) housed inside the casing 12. The casing 12 includes a front casing 12a and a rear casing 12b. The front casing 12a constitutes front halves of outer shapes of the main body 4, the right support 6, the left support 8, and the handle 10. The rear casing 12b constitutes rear halves of the outer shapes of the main body 4, the right support 6, the left support 8, and the handle 10.

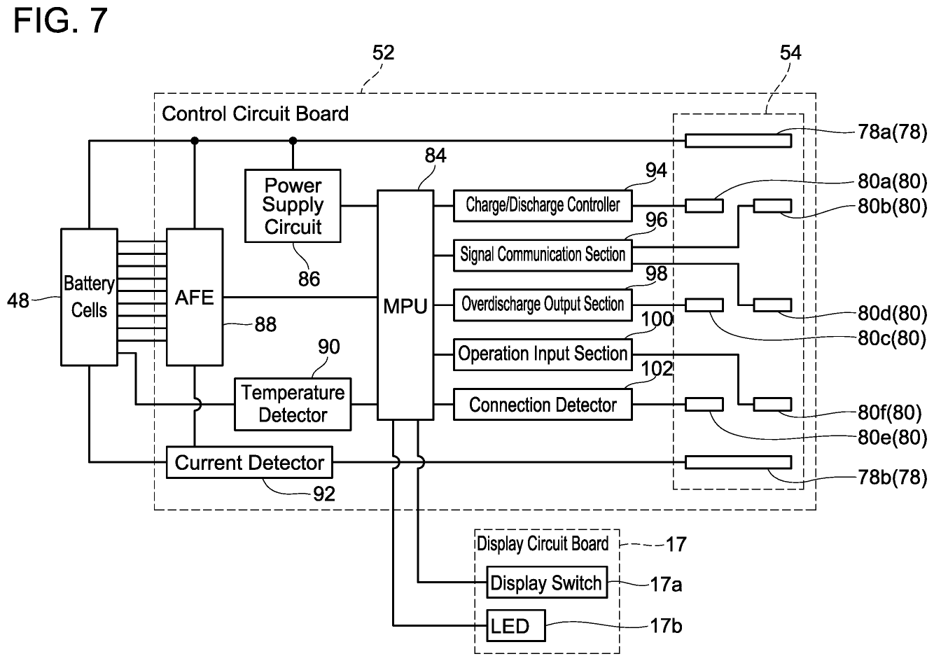

As shown in FIG. 2, a remaining charge indicator 16 and a remaining charge display button 18 are arranged near the front end of the upper surface 4e of the main body 4. The remaining charge indicator 16 is configured to display remaining charge of the battery pack 2. The remaining charge display button 18 is a button for the user to perform an on-operation for the indication of the remaining charge by the remaining charge indicator 16. The remaining charge indicator 16 is turned on when the on-operation is performed on the remaining charge display button 18 and is automatically turned off after a predetermined time. In the front-rear direction, the remaining charge indicator 16 and the remaining charge display button 18 are arranged on the front side of the handle 10. In the left-right direction, the remaining charge indicator 16 and the remaining charge display button 18 are arranged on the left side of the right support 6 and on the right side of the left support 8. As shown in FIG. 3, a display circuit board 17 is housed inside the casing 12 below the remaining charge indicator 16 and the remaining charge display button 18. The display circuit board 17 is held by the front casing 12a. The display circuit board 17 includes a display switch 17a (see FIG. 7) for detecting operations performed by the user on the remaining charge display button 18 and a plurality of LEDs 17b (see FIG. 7) for turning on and turning off the remaining charge indicator 16.

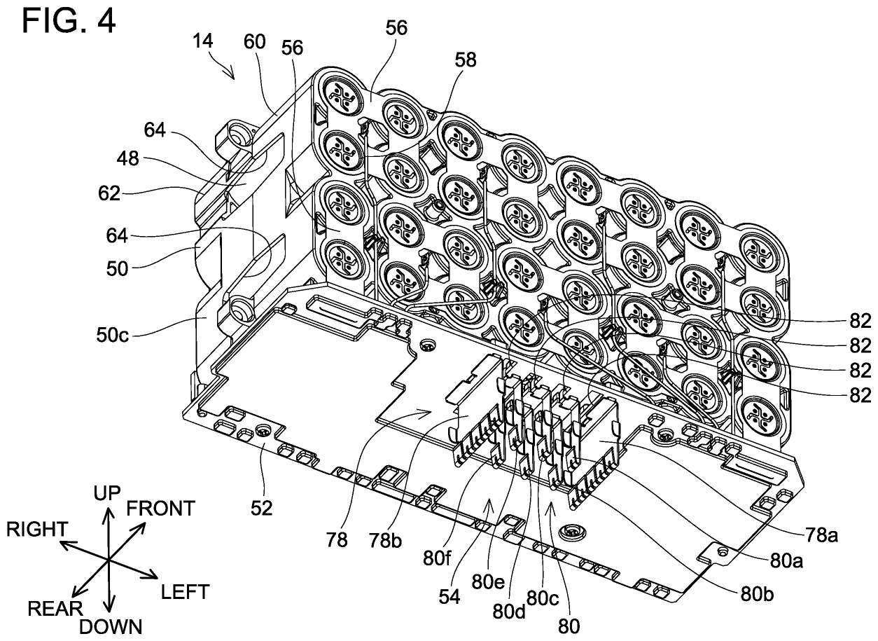

As shown in FIG. 1, a terminal interface (hereinbelow may be denoted as IF) unit 20 is arranged at a front lower portion near the center of the main body 4 in the left-right direction. The terminal IF unit 20 includes a plurality of terminal receptacles 22 arranged side by side in the left-right direction. A terminal opening 24 is defined in a lower surface of each of the terminal receptacles 22. The terminal openings 24 are slit-shaped through holes having their longitudinal direction in the front-rear direction. Each of the terminal receptacles 22 houses a battery-side terminal 54 (see FIG. 4). When the battery pack 2 is to be attached to the electric device or the charger, device-side terminals (not shown) of the electric device or the charger enter into the terminal receptacles 22 through the terminal openings 24. Due to this, the device-side terminals of the electric device or the charger come into mechanical contact with and thereby is electrically connected to the battery-side terminals 54.

A first guide groove 26 and a second guide groove 28 extending upward from the lower end of the right surface 4c are defined in the right surface 4c of the main body 4. As shown in FIG. 2, a first guide groove 30 and a second guide groove 32 extending upward from the lower end of the left surface 4d are defined in the left surface 4d of the main body 4. When the battery pack 2 is to be attached to the electric device or the charger, the battery pack 2 is positioned with respect to the electric device or the charger and also a moving direction of the battery pack 2 with respect to the electric device or the charger is defined by guide ribs (not shown) arranged on the electric device or the charger entering into the first guide grooves 26, 30 and the second guide grooves 28, 32. Further, as shown in FIG. 1, a hook engaging groove 34 is defined in the front surface 4a of the main body 4. When the battery pack 2 is to be attached to the electric device, the battery pack 2 is fixed to the electric device by a hook (not shown) of the electric device engaging with the hook engaging groove 34.

A plurality of air supply openings 36 is defined in the right surface 4c of the main body 4. As shown in FIG. 2, a plurality of air supply openings 38 is defined in the left surface 4d of the main body 4. As shown in FIG. 1, a plurality of air supply openings 40 is defined in the front surface 4a of the main body 4. As shown in FIG. 2, a plurality of exhaust openings 42 is defined in the rear surface 4b of the main body 4.

As shown in FIG. 3, a rib 44 is arranged for each of the plurality of air supply openings in the front surface 4a of the main body 4. The ribs 44 each include a bottom plate 44a that protrudes rearward from a lower edge of its corresponding air supply opening 40 and then bends rearward and upward, and side plates 44b that protrude rearward from left and right edges of its corresponding air supply opening 40 and then are connected with left and right ends of the bottom plate 44a. By arranging the ribs 44 for the air supply openings 40, the inside of the main body 4 can be suppressed from being visually recognizable through the air supply openings 40 to the user holding the handle 10. Further, by providing the ribs 44 for the air supply openings 40, entry of water and foreign objects from outside to inside the main body 4 through the air supply openings can be suppressed.

A rib 46 is arranged for each of the plurality of exhaust openings 42 in the rear surface 4b of the main body 4. The ribs 46 each include a bottom plate 46a that protrudes frontward from a lower edge of its corresponding exhaust opening 42 and then bends frontward and upward, and side plates 46b that protrude frontward from left and right edges of its corresponding exhaust opening 42 and then are connected with left and right ends of the bottom plate 46a. By arranging the ribs 46 for the exhaust openings 42, the inside of the main body 4 can be suppressed from being visually recognizable through the exhaust openings 42 to the user holding the handle 10. Further, by providing the ribs 46 for the exhaust openings 42, entry of water and foreign objects from outside to inside the main body 4 through the exhaust openings 42 can be suppressed.

As shown in FIG. 4, the battery cell unit 14 includes a plurality of battery cells 48, a cell holder 50 constituted of resin and configured to hold the plurality of battery cells 48, and a control circuit board 52 held by the cell holder 50 at a lower portion of the cell holder 50. Battery-side terminals 54 are arranged on a lower surface of the control circuit board 52.

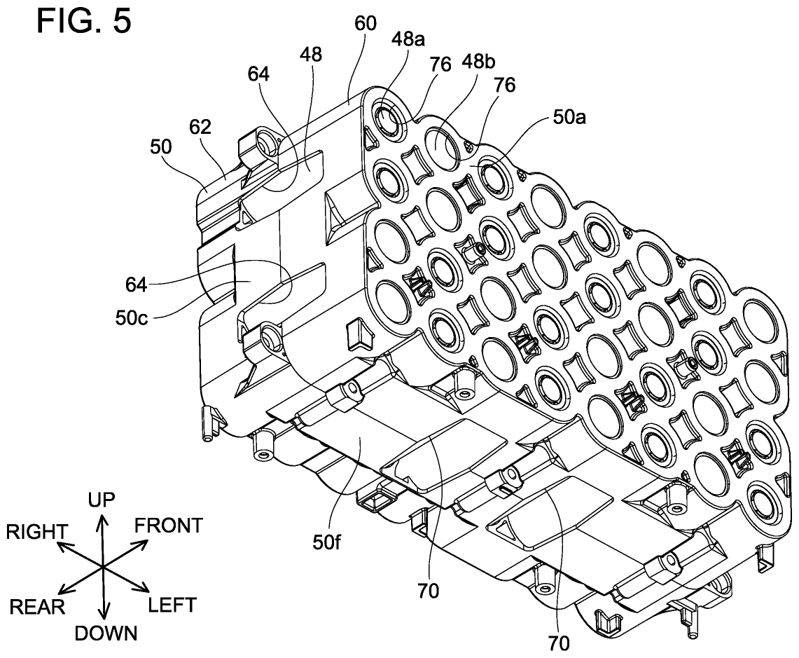

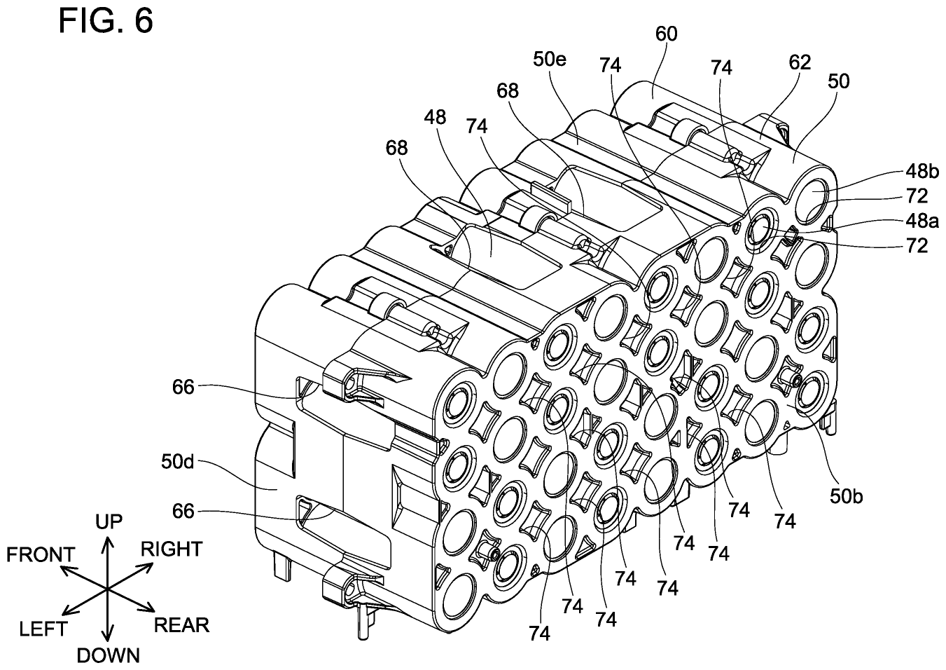

Each of the plurality of battery cells 48 may for example be a lithium ion battery cell. Each of the plurality of battery cells 48 has a substantially cylindrical shape, and is arranged such that its longitudinal direction is along the front-rear direction. The shape of each of the plurality of battery cells 48 may for example be of type 18650 with a diameter of 18 mm and a dimension in the longitudinal direction of 65 mm. The plurality of battery cells 48 is arranged in four rows that are stacked along the up-down direction. The plurality of battery cells 48 is arranged in eight columns that are arranged along the left-right direction. The plurality of battery cells 48 is thus arranged in a grid pattern, such as in a square grid pattern. In the up-down direction, positions of the battery cells 48 in the same row are substantially the same, and the battery cells 48 in the same row are arranged with intervals in between them along the left-right direction. In the left-right direction, positions of the battery cells 48 in the same column are substantially the same, and the battery cells 48 in the same column are arranged with intervals in between them along the up-down direction. As shown in FIGS. 5 and 6, each of the plurality of battery cells 48 has a positive electrode 48a at one of its front and rear ends and a negative electrode 48b at the other of its front and rear ends. Metal lead plates 56 (see FIG. 4) are attached to the positive electrodes 48a and the negative electrodes 48b of the plurality of battery cells 48. As shown in FIG. 4, some of the lead plates 56 are electrically connected to the control circuit board 52 by being directly inserted into the control circuit board 52, and the rest of the lead plates 56 are electrically connected to the control circuit board 52 via lead wires 58.

As shown in FIGS. 5 and 6, the cell holder 50 has a substantially box shape. The cell holder 50 includes a front surface 50a, a rear surface 50b, a right surface 50c, a left surface 50d, an upper surface 50e, and a lower surface 50f. The cell holder 50 includes a front cell holder 60 and a rear cell holder 62. The front cell holder 60 holds the front ends of the plurality of battery cells 48. The rear cell holder 62 holds the rear ends of the plurality of battery cells 48.

As shown in FIG. 5, a plurality of air supply openings 64 is defined in the right surface 50c of the cell holder 50. In the present embodiment, two air supply openings 64 are defined in the right surface 50c of the cell holder 50, where one of the air supply openings 64 is arranged facing a space between the battery cells 48 in the first row from top and the battery cells 48 in the second row from top inside the cell holder 50, and the other of the air supply openings 64 is arranged facing a space between the battery cells 48 in the first row from bottom and the battery cells 48 in the second row from bottom inside the cell holder 50.

As shown in FIG. 6, a plurality of air supply openings 66 is defined in the left surface 50d of the cell holder 50. In the present embodiment, two air supply openings 66 are defined in the left surface 50d of the cell holder 50, where one of the air supply openings 66 is arranged facing the space between the battery cells 48 in the first row from top and the battery cells 48 in the second row from top inside the cell holder 50, and the other of the air supply openings 66 is arranged facing the space between the battery cells 48 in the first row from bottom and the battery cells 48 in the second row from bottom inside the cell holder 50.

A plurality of air supply openings 68 is defined in the upper surface 50e of the cell holder 50. In the present embodiment, two air supply openings 68 are defined in the upper surface 50e of the cell holder 50, where one of the air supply openings 68 is arranged facing a space between the battery cells 48 in the third column from right and the battery cells 48 in the fourth column from right inside the cell holder 50, and the other of the air supply openings 68 is arranged facing a space between the battery cells 48 in the third column from left and the battery cells 48 in the fourth column from left inside the cell holder 50.

As shown in FIG. 5, a plurality of air supply openings 70 is defined in the lower surface 50f of the cell holder 50. In the present embodiment, two air supply openings 70 are defined in the lower surface 50f of the cell holder 50, where one of the air supply openings 70 is arranged facing the space between the battery cells 48 in the third column from right and the battery cells 48 in the fourth column from right inside the cell holder 50, and the other of the air supply openings 70 is arranged facing the space between the battery cells 48 in the third column from left and the battery cells 48 in the fourth column from left inside the cell holder 50.

Each of the plurality of air supply openings 64, 66, 68, 70 is defined to traverse over the front cell holder 60 and the rear cell holder 62. Each of the plurality of air supply openings 64, 66, 68, 70 has an elongate hole-shape having its longitudinal direction along the front-rear direction. A front end of each of the plurality of air supply openings 64, 66, 68, 70 is arranged for example at a position rearward from the front ends of the plurality of battery cells 48 by ¼ the length of the plurality of battery cells 48 in the front-rear direction. A rear end of each of the plurality of air supply openings 64, 66, 68, 70 is arranged for example at a position frontward from the rear ends of the plurality of battery cells 48 by ¼ the length of the plurality of battery cells 48 in the front-rear direction.

As shown in FIG. 6, a plurality of electrode openings 72 and a plurality of exhaust openings 74 are defined in the rear surface 50b of the cell holder 50. The plurality of electrode openings 72 is arranged corresponding to the rear ends of the plurality of battery cells 48, and the positive electrode 48a or the negative electrode 48b of each battery cell 48 is exposed from its corresponding electrode opening 72. The lead plates 56 (see FIG. 4) are arranged behind the rear surface 50b of the cell holder 50, and contact the positive electrodes 48a or the negative electrodes 48b of the battery cells 48 through the electrode openings 72. Each of the plurality of exhaust openings 74 is arranged at a position surrounded by four electrode openings 72. That is, the plurality of exhaust openings 74 is each arranged facing a space surrounded by four battery cells 48 inside the cell holder 50. Between the battery cells 48 in the first column from right and the battery cells 48 in the second column from right, exhaust openings 74 are not defined in the rear surface 50b of the cell holder 50. Further, also between the battery cells 48 in the first column from left and the battery cells 48 in the second column from left, exhaust openings 74 are not defined in the rear surface 50b of the cell holder 50. Moreover, between the battery cells 48 in the second row from top and the battery cells 48 in the third row from top (that is, second row from bottom), the exhaust openings 74 are defined between the battery cells 48 in the third column from right and the battery cells 48 in the fourth column from right and between the battery cells 48 in the third column from left and the battery cells 48 in the fourth column from left, however, exhaust openings 74 are not defined in positions other than the above.

As shown in FIG. 5, a plurality of electrode openings 76 is defined in the front surface 50a of the cell holder 50. The plurality of electrode openings 76 is arranged corresponding to the front ends of the plurality of battery cells 48, and the positive electrode 48a or the negative electrode 48b of each battery cell 48 is exposed from its corresponding electrode opening 76. The lead plates 56 (see FIG. 4) are arranged in front of the front surface 50a of the cell holder 50, and contact the positive electrodes 48a or the negative electrodes 48b of the battery cells 48 through the electrode openings 76. Unlike the rear surface 50b of the cell holder 50, openings other than the electrode openings 76 are not defined in the front surface 50a of the cell holder 50.

As shown in FIG. 4, the battery-side terminals 54 include power terminals 78 and signal terminals 80. The power terminals 78 include a positive power terminal 78a and a negative power terminal 78b arranged rightward of the positive power terminal 78a. The signal terminals 80 are arranged between the positive power terminal 78a and the negative power terminal 78b. The signal terminals 80 include a charge/discharge control terminal 80a arranged adjacent to and on the right side of the positive power terminal 78a, a signal-receiving terminal 80b arranged adjacent to and on the right side of the positive power terminal 78a and behind the charge/discharge control terminal 80a, an overdischarge output terminal 80c arranged adjacent to and on the right side of the charge/discharge control terminal 80a, a signal-sending terminal 80d arranged adjacent to and on the right side of the signal-receiving terminal 80b and behind the overdischarge output terminal 80c, a connection detecting terminal 80e arranged adjacent to and on the right side of the overdischarge output terminal 80c, and an operation input terminal 80f arranged adjacent to and on the right side of the signal-sending terminal 80d and behind the connection detecting terminal 80e.

The positive power terminal 78a and the negative power terminal 78b use a Cu alloy as their base material, Cu plating is applied thereto as their basecoat plating, and Sn plating is applied to the top of the basecoat plating. Plating using a pure metal that is a base metal, such as Ni, may be applied instead of the Sn plating, and as another alternative, plating using a pure metal that is a noble metal other than Ag, such as Au, may be applied. As yet another alternative, plating using an alloy not containing Ag may be applied.

When the battery pack 2 is used in a high-moisture environment, metal on a surface of the positive power terminal 78a may be ionized, move on the control circuit board 52 toward the negative power terminal 78b, and deposit as metal on a surface of the negative power terminal 78b. Such a phenomenon is called ion migration. When the metal deposited on the negative power terminal 78b grows on the control circuit board 52, short-circuiting may occur in the control circuit board 52. Ag is most prone to the ion migration. Further, since the ion migration tends to occur when a large voltage is applied while the ion migration tends not to occur when a small voltage is applied, it tends to occur in the power terminals 78 and tends not occur in the signal terminals 80. Due to this, as aforementioned, by applying plating using a pure metal other than Ag or plating using an alloy not containing Ag on the positive power terminal 78a and the negative power terminal 78b, the short-circuiting caused by the ion migration can be suppressed. Especially by applying plating using a pure metal other than Ag or plating using an alloy not containing Ag on the surface of the positive power terminal 78a, Ag ionization on the surface of the positive power terminal 78a can be suppressed, and the short-circuiting caused by the ion migration can be suppressed. The pure metal other than Ag or the alloy not containing Ag as aforementioned may be a pure metal other than Ag, Pb or an alloy not containing Ag, Pb, or may be a pure metal other than Ag, Pb, Cu or an alloy not containing Ag, Pb, Cu.

The charge/discharge control terminal 80a, the signal-receiving terminal 80b, the overdischarge output terminal 80c, the signal-sending terminal 80d, the connection detecting terminal 80e, and the operation input terminal 80f use Cu alloy as their base material, Cu plating is applied thereto as their basecoat plating, and Ag plating is applied to the top of the basecoat plating. Plating using a pure metal that is a noble metal, such as Au, or noble metal alloy plating may be applied instead of the Ag plating.

In the state in which the battery pack 2 is attached to the electric device or the charger, the battery-side terminals 54 are maintained in contact with device-side terminals of the electric device or the charger. In this state, when micro-vibration is repeatedly applied to the battery-side terminals 54, partial wear progresses on surfaces of the battery-side terminals 54, by which metal debris worn off of the surfaces of the battery-side terminals 54 oxidizes and accumulates on the surfaces of the battery-side terminals 54. Such a phenomenon is called fretting corrosion. As the oxidized debris accumulates on the surfaces of the battery-side terminals 54, conduction defects of the battery-side terminals 54 could occur. In general, noble metals tend not to oxidize, thus they are resistant against such conduction defects caused by the fretting corrosion. To the contrary, since base metals are prone to oxidization, they are susceptible to such conduction defects caused by the fretting corrosion. Further, the conduction defects caused by the fretting corrosion tends not to occur when a large voltage is applied whereas they tend to occur when a small voltage is applied, thus the conduction defects tend not to occur in the power terminals 78 and tend to occur in the signal terminals 80. Therefore, by plating the charge/discharge control terminal 80a, the signal-receiving terminal 80b, the overdischarge output terminal 80c, the signal-sending terminal 80d, the connection detecting terminal 80e, and the operation input terminal 80f using a pure metal that is a noble metal or a noble metal alloy as aforementioned, the conduction defects caused by the fretting corrosion can be suppressed.

A plurality of through holes 82 is defined in the control circuit board 52. In the present embodiment, four through holes 82 are defined in the control circuit board 52. One of the through holes 82 extends in the front-rear direction between the positive power terminal 78a and the charge/discharge control terminal 80a and also between the positive power terminal 78a and the signal-receiving terminal 80b. Another one of the through holes 82 extends in the front-rear direction between the charge/discharge control terminal 80a and the overdischarge output terminal 80c and also between the signal-receiving terminal 80b and the signal-sending terminal 80d. Yet another one of the through holes 82 extends in the front-rear direction between the overdischarge output terminal 80c and the connection detecting terminal 80e and also between the signal-sending terminal 80d and the operation input terminal 80f. Last one of the through holes 82 extends in the front-rear direction between the connection detecting terminal 80e and the negative power terminal 78b and also between the operation input terminal 80f and the negative power terminal 78b. By having the plurality of through holes 82 defined in the control circuit board 52, even when a conductive substance such as water adheres to the surface of the control circuit board 52, short-circuiting between the power terminals 78, between the signal terminals 80, and between the power terminals 78 and the signal terminals 80 can be suppressed.

As shown in FIG. 7, the plurality of battery cells 48 is electrically connected between the positive power terminal 78a and the negative power terminal 78b. The control circuit board 52 includes a Micro Processing Unit (MPU) 84, a power supply circuit 86, an Analog Front End (AFE) 88, a temperature detector 90, a current detector 92, a charge/discharge controller 94, a signal communication section 96, an overdischarge output section 98, an operation input section 100, and a connection detector 102. The MPU 84 is configured to control operation of the battery pack 2. The MPU 84 is electrically connected to the display switch 17a and the LEDs 17b of the display circuit board 17. The power supply circuit 86 is configured to step down DC power from the plurality of battery cells 48 to a voltage suitable for operation of the MPU 84 and supplies the same to the MPU 84. The current detector 92 is configured to detect current flowing in the plurality of battery cells 48 and output the same to the AFE 88. The AFE 88 is configured to amplify the voltage of the respective battery cells 48 and the current detected by the current detector 92 such that they can be identified by the MPU 84, and output the same to the MPU 84. The temperature detector 90 is configured to detect temperatures of the plurality of battery cells 48 using a thermistor (not shown) arranged in the cell holder 50 and output the same to the MPU 84. The charge/discharge controller 94 electrically connects the MPU 84 and the charge/discharge control terminal 80a. The charge/discharge controller 94 is configured to output a charge/discharge permitting signal to the charge/discharge control terminal 80a in the case in which the battery pack 2 is in a normal state, and output a charge/discharge prohibiting signal to the charge/discharge control terminal 80a in the case in which the battery pack 2 is in an abnormal state. The signal communication section 96 electrically connects between the MPU 84 and the and the signal-receiving terminal 80b and also electrically connects between the MPU 84 and the signal-sending terminal 80d. The signal communication section 96 is configured to input, to the MPU 84, a signal received by the signal-receiving terminal 80b by serial communication, and send a signal outputted from the MPU 84 using the signal-sending terminal 80d in serial communication. The overdischarge output section 98 electrically connects between the MPU 84 and the overdischarge output terminal 80c. The overdischarge output section 98 is configured to output, to the overdischarge output terminal 80c, a signal indicating that overdischarge is taking place when the plurality of battery cells 48 is overdischarging. The operation input section 100 electrically connects between the MPU 84 and the operation input terminal 80f. In the state in which the battery pack 2 is attached to the electric device, the operation input section 100 is configured to use the operation input terminal 80f to receive an operation input signal, which is sent from the electric device when an operation switch of the electric device is turned on by a user, and inputs the same to the MPU 84. The connection detector 102 electrically connects between the MPU 84 and the connection detecting terminal 80e. The connection detector 102 is configured to input a connection detecting signal to the MPU 84 when the battery pack 2 is electrically connected to the electric device or the charger. The configuration shown in FIG. 7 is merely an example, and in particular, the signal terminals 80 and/or constituent elements connected to the signal terminals 80 may be of types other than those as aforementioned, and the numbers of the signal terminals 80 and the constituents may be different from the aforementioned numbers.

When the battery pack 2 is attached to the charger, the plurality of battery cells 48 is cooled by a fan device (not shown) of the charger while the plurality of battery cells 48 is charged to suppress the plurality of battery cells 48 from reaching excessively high temperatures. In the battery pack 2 of the present embodiment, air is suctioned from inside to outside the casing 12 through the exhaust openings 42 in the rear surface 4b of the main body 4 as shown in FIG. 2 by the fan device of the charger. Hereinbelow, airflow inside the casing 12 upon when the plurality of battery cells 48 is cooled as above will be described.

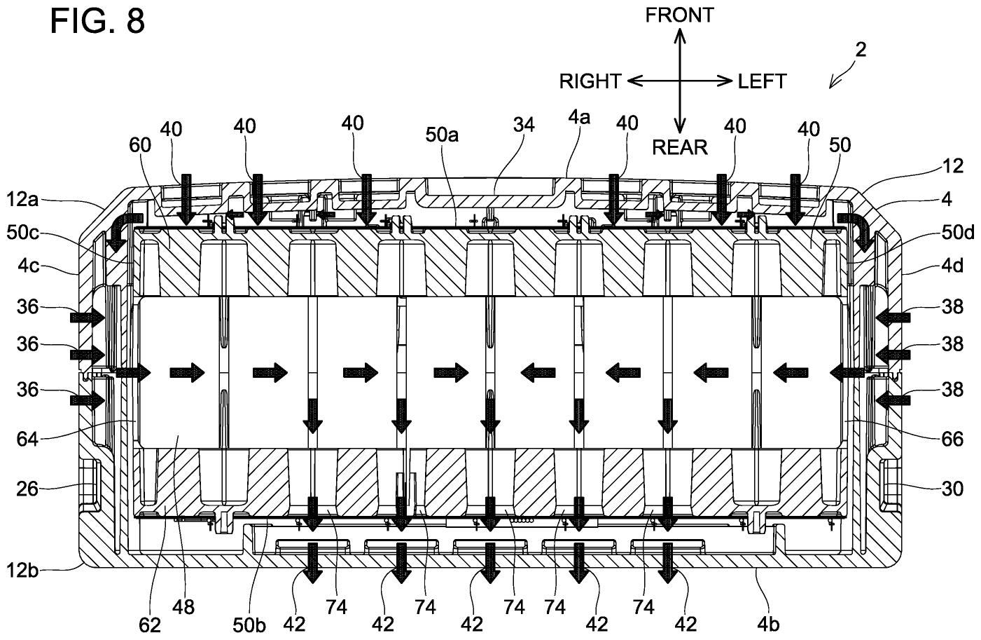

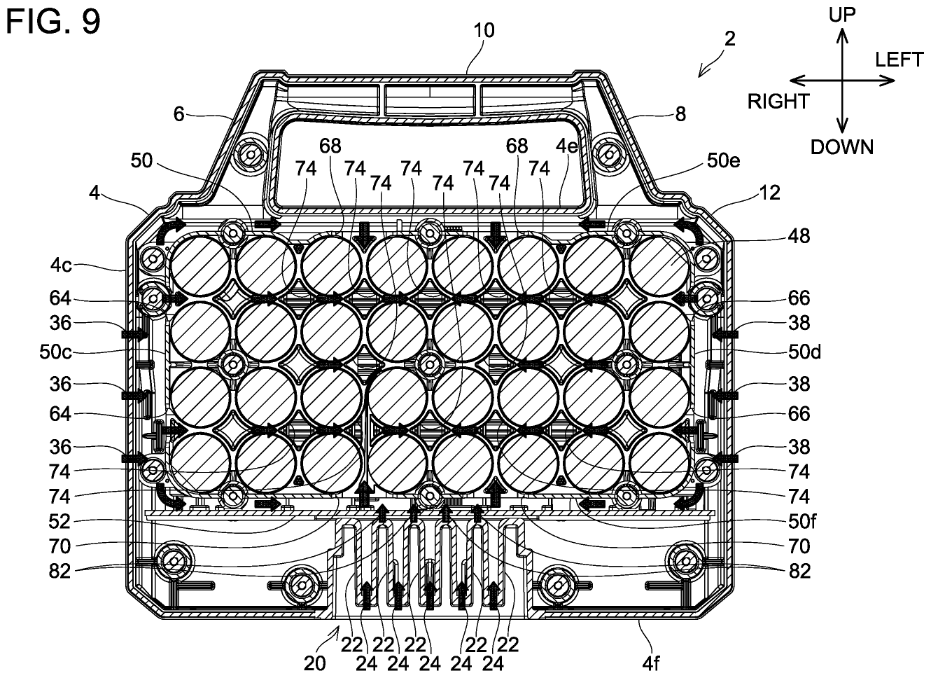

As shown in FIG. 8, when the air is suctioned from inside to outside the casing 12 through the exhaust openings 42 in the rear surface 4b of the main body 4, air flows in from outside to inside the casing 12 through the air supply openings 36 in the right surface 4c of the main body 4, the air supply openings 38 in the left surface 4d of the main body 4, and the air supply openings in the front surface 4a of the main body 4. Further, as shown in FIG. 9, the air flows in from outside to inside the casing 12 through the terminal openings 24 of the terminal IF unit 20 although a volume of the air is small.

Majority of the air that entered from the air supply openings 36 flows into the cell holder 50 through the plurality of air supply openings 64 in the right surface 50c of the cell holder 50. Remainder of the air that entered from the air supply openings 36 flows in a space between the casing 12 and the cell holder 50, and flows into the cell holder 50 through the plurality of air supply openings 68 in the upper surface 50e of the cell holder 50 and the plurality of air supply openings 70 in the lower surface 50f of the cell holder 50.

Majority of the air that entered from the air supply openings 38 flows into the cell holder 50 through the plurality of air supply openings 66 of the left surface 50d of the cell holder 50. Remainder of the air that entered from the air supply openings 38 flows in the space between the casing 12 and the cell holder 50, and flows into the cell holder 50 through the plurality of air supply openings 68 in the upper surface 50e of the cell holder 50 and the plurality of air supply openings 70 in the lower surface 50f of the cell holder 50.

As shown in FIG. 8, the air that entered from the air supply openings 40 flows in the space between the casing 12 and the cell holder 50, and flows into the cell holder 50 through the plurality of air supply openings 64 in the right surface 50c of the cell holder 50, the plurality of air supply openings 66 in the left surface 50d of the cell holder 50, the plurality of air supply openings 68 in the upper surface 50e of the cell holder 50, and the plurality of air supply openings 70 in the lower surface 50f of the cell holder 50.

As shown in FIG. 9, the air that entered from the terminal openings 24 flows through the through holes 82 in the control circuit board 52 and flows into the cell holder 50 through the plurality of air supply openings 70 in the lower surface 50f of the cell holder 50.

The air that entered inside the cell holder 50 from the plurality of air supply openings 64 flows from right to left in spaces between the battery cells 48 that are adjacent in the up-down direction. The air that entered inside the cell holder 50 from the plurality of air supply openings 66 flows from left to right in spaces between the battery cells 48 that are adjacent in the up-down direction. The air that entered inside the cell holder 50 from the plurality of air supply openings 68 flows downward from above in spaces between the battery cells 48 that are adjacent in the left-right direction. The air that entered inside the cell holder 50 from the plurality of air supply openings 70 flows upward from below in spaces between the battery cells 48 that are adjacent in the left-right direction.

As shown in FIG. 8, at portions of the rear surface 50b of the cell holder 50 where the plurality of exhaust openings 74 is defined, airflow directed rearward from front is generated along the longitudinal direction of each of the battery cells 48. Consequently, the air that entered inside the cell holder 50 from the plurality of air supply openings 64, 66, 68, 70 flows either in the left-right direction or in the up-down direction in the spaces between the plurality of battery cells 48, then flows rearward from front, and thereafter flows out from the cell holder 50 through the plurality of exhaust openings 74. The air that flowed out from the cell holder 50 through the plurality of exhaust openings 74 flows out from the casing 12 through the plurality of exhaust openings 42 in the rear surface 4b of the main body 4. The plurality of battery cells 48 is cooled by the airflow as aforementioned.

As described above, in one or more embodiments, the battery pack 2 is configured to be attached to and detached from the electric device or the charger including the device-side terminals. The battery pack 2 comprises: the battery cells 48; the control circuit board 52 (an example of the circuit board) electrically connected to the battery cells 48; and the battery-side terminals 54 electrically connected to the control circuit board 52, and configured to electrically connect to the device-side terminals by contacting the device-side terminals. The battery-side terminals 54 comprise: the positive power terminal 78a and the negative power terminal 78b for discharging from the battery cells 48 and charging the battery cells 48; and at least one signal terminal 80 electrically connected to the control circuit board 52 for signal communication with the control circuit board 52. The positive power terminal 78a is plated with a first metal on its surface. One of the at least one signal terminal 80 is plated with a second metal on its surface. The first metal is a pure metal other than Ag or an alloy not containing Ag. The second metal is a pure metal that is a noble metal or a noble metal alloy.

According to the above configuration, short-circuiting caused by ion migration and conduction defects caused by fretting corrosion can be suppressed in the battery-side terminals 54 of the battery pack 2.

In one or more embodiments, the negative power terminal 78b is plated with a third metal on its surface. The third metal is a pure metal other than Ag or an alloy not containing Ag.

According to the above configuration, the short-circuiting caused by the ion migration can be suppressed in the battery-side terminals 54 of the battery pack 2.

In one or more embodiments, the third metal is the same metal as the first metal.

According to the above configuration, since plating processes to be performed on the positive power terminal 78a and the negative power terminal 78b can be integrated, manufacture of the battery pack 2 can be facilitated.

In one or more embodiments, all of the at least one signal terminal 80 is plated with the second metal on the surface.

According to the above configuration, since plating processes to be performed on all of the at least one signal terminal 80 can be integrated, the manufacture of the battery pack 2 can further be facilitated.

In one or more embodiments, the first metal is Sn.

According to the above configuration, among the battery-side terminals 54, sliding performance of terminal(s) plated with the first metal (for example, the positive power terminal 78a, the negative power terminal 78b) to slide on the device-side terminal(s) can be improved.

In one or more embodiments, the second metal is Ag.

According to the above configuration, an electric resistance of terminal(s) plated with the second metal (for example the signal terminals 80) among the battery-side terminals 54 can be reduced.

What is claimed is:

1. A battery pack configured to be attached to and detached from an electric device or a charger including device-side terminals, the battery pack comprising:
a battery cell;
a circuit board electrically connected to the battery cell; and
battery-side terminals electrically connected to the circuit board and configured to electrically connect to the device-side terminals by contacting the device-side terminals,
wherein the battery-side terminals comprise:
a positive power terminal and a negative power terminal for discharging from the battery cell and charging the battery cell; and
at least one signal terminal electrically connected to the circuit board for signal communication with the circuit board,
wherein the positive power terminal is plated with a first metal on its surface,
one of the at least one signal terminal is plated with a second metal on its surface,
the first metal is a pure metal other than Ag or an alloy not containing Ag, and
the second metal is a pure metal that is a noble metal or a noble metal alloy.

2. The battery pack according to claim 1, wherein the negative power terminal is plated with a third metal on its surface, and
the third metal is a pure metal other than Ag or an alloy not containing Ag.

3. The battery pack according to claim 2, wherein the third metal is the same metal as the first metal.

4. The battery pack according to claim 1, wherein all of the at least one signal terminal is plated with the second metal on the surface.

5. The battery pack according to claim 1, wherein the first metal is Sn.

6. The battery pack according to claim 1, wherein the second metal is Ag.

7. The battery pack according to claim 3, wherein
all of the at least one signal terminal is plated with the second metal on the surface,
the first metal is Sn, and
the second metal is Ag.
